(19) United States
(12) Patent Application Publication
(10) Pub. No.: US 2021/0154564 A1
(43) Pub. Date: May 27, 2021

(54) SNOWBOARD BINDING HIGHBACK HAVING AN UPPER PORTION OF UNIFORM MATERIAL

(71) Applicant: Low Pressure Studio B.V., Amsterdam (NL)

(72) Inventor: Justin Frappier, South Burlington, VT (US)

(73) Assignee: Low Pressure Studio B.V., Amsterdam (NL)

(21) Appl. No.: 16/694,217

(22) Filed: Nov. 25, 2019

(51) Int. Cl. A63C 10/24; A63C 10/00; B29C 45/14

(52) U.S. Cl. CPC A63C 10/24; A63C 10/005; A63C 10/06; B29C 45/14344; B29C 45/14065

(57) ABSTRACT

A highback for a snowboard binding, and method of creating same, includes a lower portion configured to couple the highback to a baseplate of the snowboard binding such that a proximal end of the first portion is proximate the baseplate. An upper portion having a first section and second section is formed from a uniform material. The first section is anchored within the lower portion and the second section extends from a distal end of the lower portion away from the proximal end.

### FIELD OF THE TECHNOLOGY

The subject disclosure relates to sporting equipment, and more particularly to highbacks for snowboard bindings.

### BACKGROUND OF THE TECHNOLOGY

Snowboard bindings include highbacks which run along the backside of a snow boarder's lower leg and are used for controlling the snowboard. For turning, the snowboarder will typically lean into the highback of the snowboard binding to pressure the snowboard edge against the snow. This action helps initiate a turn on the heel edge of the snowboard.

Highbacks are often made up of a single material. This can be an injection plastic material or composite (e.g. glass or carbon fiber reinforced nylon). Sometimes these highbacks can include foam padding for the snowboard boot to push against (e.g. glued to the inside surface of the highback). The foam padding provides comfort and protects the snowboard boot from highback abrasion, but does not affect the function of the highback and is not a required component. Thus, the highback itself is essentially a single material.

One drawback of single material highbacks is that they lack stiffness and/or are unable to flex in a controlled manner. Stiffness can be gained by adding material thickness perpendicular to the forces applied on the highback. Adding more material, or rib features, can improve stiffness but leads to a binding that is heavier than desirable and/or bulky looking. Increasing flex in this way can also make the highback brittle and susceptible to cracking at the mounting points or along the vertical axis (i.e. torsion flex). Further, too much support can make the highback uncomfortable because of a lack of flex around the vertical axis, some flex being desirable to snowboarders, particularly when performing maneuvers such as grabs, spins and inverted flips which require flex laterally.

The highback can also include holes or coring in some areas to add lightness, aesthetic technical appeal, and targeted softer or flexible regions. No matter the quantity or size of holes typically used on a highback, the material is always flexed and stressed when loaded, which gives rise to concerns of breakage that can be difficult to address while still keeping the material light and flexible. It is difficult to have the ideal level of flex and stiffness in a single uniform material highback.

To combat the problems described above, some highbacks use two separate materials, including a more flexible material and a more rigid material that allows for a better strength to flex to weight ratios that one material highbacks cannot achieve.

It is also difficult to effectively incorporate two materials into a single highback for a desired effect. For example, a recess can be molded into a first material and filled with a second material, such as a stiffener (or just a generally stiffer injection plastic). However, this results in an overlap of both materials so the material properties are not able to be entirely independent. Further, the materials must be held together by structural components which adds additional weight and incidentally impacts the other properties of the material, such as flexure.

Therefore there is a need for a snowboard binding which minimizes stress while still providing support and comfort for the rider.

### SUMMARY OF THE TECHNOLOGY

In light of the needs described above, the subject technology relates to a two material highback for a snowboard binding which optimizes flex and stability by connecting the separate materials without any frame, margin, or the use of any additional support structure.

In at least one aspect, the subject technology relates to a highback for a snowboard binding. The highback includes a first portion configured to couple the highback to a baseplate of the snowboard binding such that a proximal end of the first portion is proximate the baseplate. The highback includes a second portion of a uniform material. The second portion has a first section anchored within the first portion and a second section extending from a distal end of the first portion, the distal end opposite the proximal end, the second section extending in a direction away from the proximal end.

In some embodiments, the first section of the second portion is lodged between two opposing support members of the first portion. In some cases, the first section of the second portion includes a plurality of perforations through the first section and the first portion includes a plurality of connecting members connecting the opposing support members of the first portion, each of the perforations being filled by a connecting member. The first portion can include a first plurality of windows extending therethrough, the windows each being a non-circular shape. The first section of the second portion can include a second plurality of windows extending therethrough, the second plurality of windows each aligned with one of the first plurality of windows and having the non-circular shape of said window. In some embodiments, the first portion further includes a third plurality of windows extending therethrough, the third plurality of windows each being a non-circular shape and surrounding a solid area of the first section. The non-circular shape of each window can be triangular.

In at least one aspect, the subject technology relates to a highback for a snowboard binding with a lower portion and upper portion. The lower portion configured to couple the highback to a baseplate of the snowboard binding such that a lower end of the lower portion is proximate the baseplate. The upper portion is a uniform material and has a lower section anchored within the lower portion. The upper portion also includes an upper section extending from an upper end of the lower portion such that the upper section is configured to support a leg of a rider when in use.

In some embodiments, the lower section is lodged between opposing support members of the lower portion including an inner support member and an outer support member. In some cases, the lower section of the upper portion includes a plurality of perforations through the lower section and the lower portion includes a plurality of connecting members extending through the perforations and connecting the inner support member and the outer support member of the lower portion. In some cases, the lower portion includes a first plurality of windows extending therethrough, each of the first plurality of windows being a non-circular shape. The lower section of the upper portion can also include a second plurality of windows extending therethrough, the second plurality of windows each being a non-circular shape and being aligned with the first plurality of windows. In some cases, the lower portion includes a third plurality of windows extending therethrough, the third plurality of windows each being a non-circular shape and surrounding a portion of the lower section of the upper portion.

In some embodiments, the lower portion is formed from a first material configured to flex in response to an applied force and the upper portion is formed from a second material configured to maintain substantially a predetermined shape in response to the applied force. In some cases, the lower portion is configured to flex along a longitudinal axis in response to the applied force, the longitudinal axis running between the lower end and the upper end of the lower portion. The first material can be an injection plastic and the second material can be a composite material. The first material can be nylon and the second material can be an extruded glass fiber with thermoplastic resin.

In at least one aspect, the subject technology relates to a method of manufacturing a highback for a snowboard binding. An upper portion of a composite material is formed, the upper portion having a first plurality of windows, the first plurality of windows each being a shape. The upper portion is clamped on opposing sides of the upper portion with an injection tool such that a plurality of pin details of the injection tool are each inserted into one of the first plurality of windows, each pin having the shape of the window into which it is inserted. A lower portion is formed around a lower section of the upper portion using the injection tool to create an overmold having an inner support member and an outer support member on opposing sides of the upper portion such that the upper portion is lodged between the inner support member and outer support member.

In some embodiments, the upper portion has a plurality of perforations therethrough and forming the overmold includes forming connecting members extending between the perforations to connect the inner support member and the outer support member. In some cases, the step of clamping the composite upper portions on opposing sides of the upper portion with an injection tool further comprises clamping a plurality of non-circular opposing clamps on either side a plurality of solid areas of the lower section of the upper portion. In some cases, the shape of the windows and pin details is non-circular.

### BRIEF DESCRIPTION OF THE DRAWINGS

So that those having ordinary skill in the art to which the disclosed system pertains will more readily understand how to make and use the same, reference may be had to the following drawings.

FIG. 1 is a front perspective view of the snowboard binding in accordance with the subject technology.

FIG. 2 is a front perspective view of the snowboard binding of FIG. 1 securing a boot.

FIG. 3 is a rear view of the highback of the snowboard binding of FIG. 1.

FIG. 4 is a front perspective view of the highback of the snowboard binding of FIG. 1.

FIG. 5 is a rear perspective view of the highback of the snowboard binding of FIG. 1.

FIG. 6 is a rear view of the upper portion of the highback of FIG. 1.

FIG. 7 is a rear view of the lower portion of the highback of FIG. 1.

FIG. 8 is a flowchart of a method of assembling the highback of FIG. 1 in accordance with the subject technology.

FIG. 9a is a rear view of the highback of FIG. 1 showing clamping forces during a method of assembling the highback in accordance with the subject technology.

FIG. 9b is a side view of the highback of FIG. 1 showing clamping forces during a method of assembling the highback in accordance with the subject technology.

FIG. 10a is a perspective view of a first side of an injection tool for assembling the highback of FIG. 1.

FIG. 10b is a perspective view of a second side of an injection tool for assembling the highback of FIG. 1.

### DETAILED DESCRIPTION

The subject technology overcomes many of the prior art problems associated with snowboard bindings. In brief summary, the subject technology provides a frameless dual material highback for a snowboard binding. The advantages, and other features of the systems and methods disclosed herein, will become more readily apparent to those having ordinary skill in the art from the following detailed description of certain preferred embodiments taken in conjunction with the drawings which set forth representative embodiments of the present invention. Like reference numerals are used herein to denote like parts. Further, words denoting orientation such as “upper”, “lower”, “distal”, and “proximate” are merely used to help describe the location of components with respect to one another. For example, an “upper” surface of a part is merely meant to describe a surface that is separate from the “lower” surface of that same part. No words denoting orientation are used to describe an absolute orientation (i.e. where an “upper” part must always be vertically above).

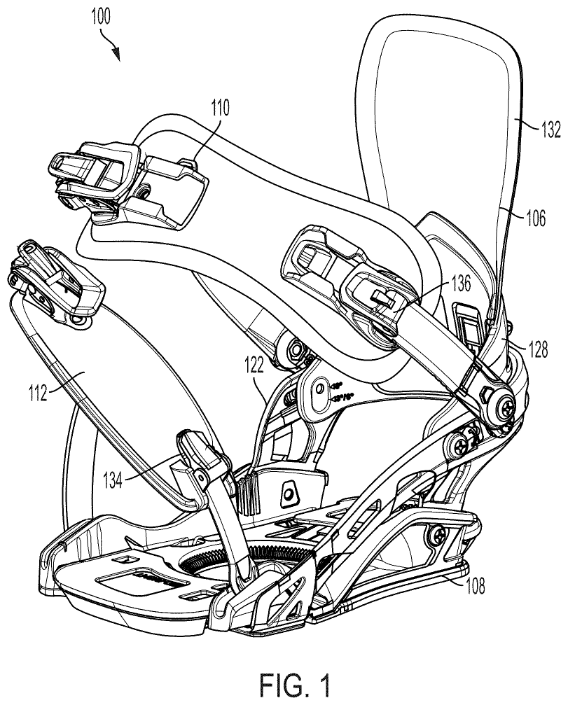

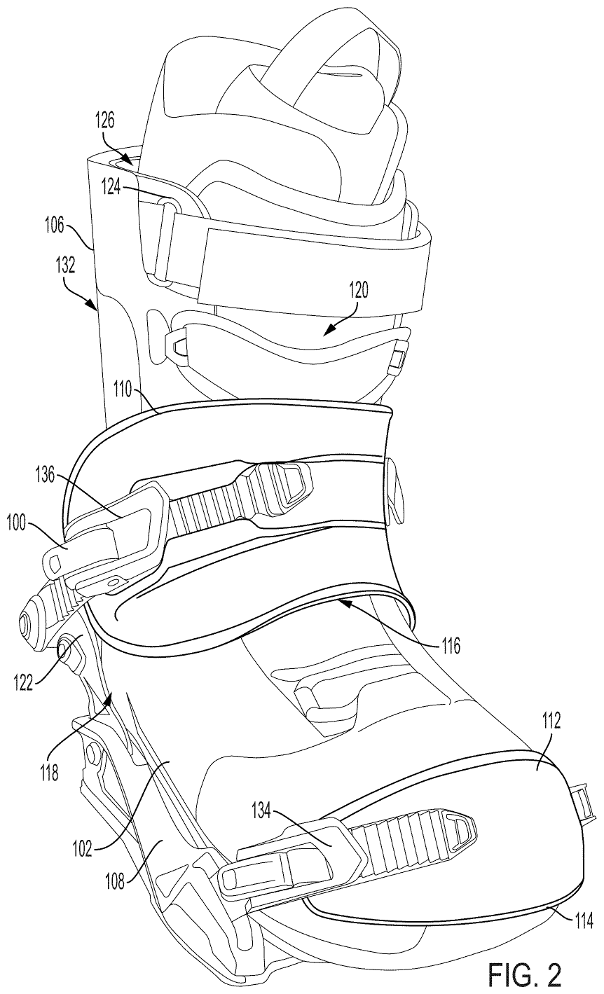

Referring now to FIGS. 1-2, a snowboard binding 100 in accordance with the subject technology is shown. In FIG. 1, the snowboard binding 100 is shown isolated form a snowboard boot, while in FIG. 2, the snowboard binding 100 is shown securing a snowboard boot 102 as it would during use. The snowboard binding 100 includes a baseplate 108, and straps 110, 112 which secure the boot 102 within the binding 100. A highback 106 includes an upper portion 132 and a lower portion 128 configured in accordance with the subject technology, as discussed in more detail below. The binding 100 shown is for an exemplary binding for a right foot snowboard boot 102 in accordance with the subject technology, it being understood that a binding for a left foot snowboard boot in accordance with the subject technology would mirror the right foot binding 100.

The baseplate 108 forms the bottom portion of the binding 100 and allows a rider to mount the snowboard binding 100 to a snowboard (not shown). When a rider places their boot 102 into the binding 100, the baseplate 108 is the base which the bottom of the rider's boot 102 contacts. For ease of explanation herein, the boot 102 will be described as having a toe region 114, ankle region 116, heel region 118, and high ankle region 120. After the rider inserts their foot into the boot 102, the toe region 114 is proximate to the location expected of a rider's toe, the ankle region 116 is proximate to the expected location of the rider's ankle, the heel region 118 is proximate to the location expected of the rider's heel, and the high ankle region 120 is proximate to the location expected rider's lower leg above the heel and ankle regions 118, 116 (the term “proximate” being used herein to describe a relative location that is closer than other portions which are not proximate, or distal).

The highback 106 is an upright support member which is fixedly coupled to the baseplate 108 of the binding 100 (either directly, or via a connector portion 122 as shown), the upper portion 132 of the highback 106 extending upward from (i.e. perpendicular to) the baseplate 108. The highback 106 has an inward curve 124 which forms a cavity 126 within which the boot 102 can be positioned. The upper portion 132 of the highback 106 is designed to provide support for the high ankle region 120 of the rider's boot 102. The lower portion 128 of the highback 106, proximate the baseplate 108, includes a heelcup 130 configured to secure the heel region 118 of the rider's boot 102 and provide flexure as the rider maneuvers.

The lower portion 128 of the highback 106 also includes corresponding lower fasteners 134 and upper fasteners 136 which attach to toe and ankle straps 112, 110, respectively. When a boot 102 is positioned within the highback 106, the ankle strap 110 can be placed across the ankle region 120 of the boot 102, which generally corresponds to a rider's ankle, such that the ankle strap 110 extends across the cavity 126 of the highback 106. The ankle fasteners 136 can then securely fasten the ankle strap 110 to opposite sides of the highback 106, and therefore across the ankle region 116 of the boot 102, while still allowing the rider to manually make adjustments for comfort. Similarly, the toe strap 112 can be placed across the toe region 114 of the boot 102. The lower fasteners 134 can then securely fasten the toe strap 112 at either side of the toe region 114 of the boot 102 to secure the boot 102 (the fasteners 134 being connected directly to the baseplate 108, or to the connector portion 122 which is connected to the baseplate 108) while still allowing the rider to manually make adjustments.

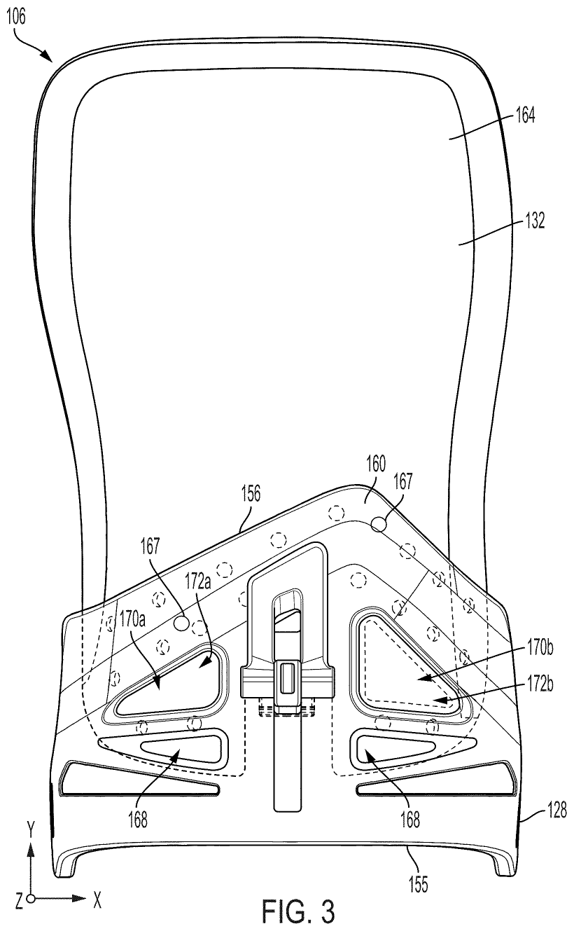

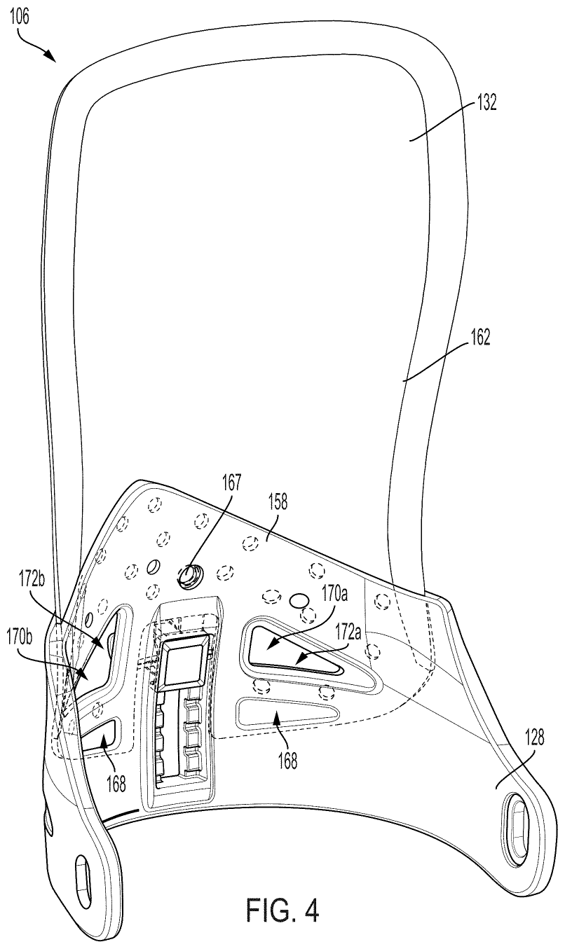

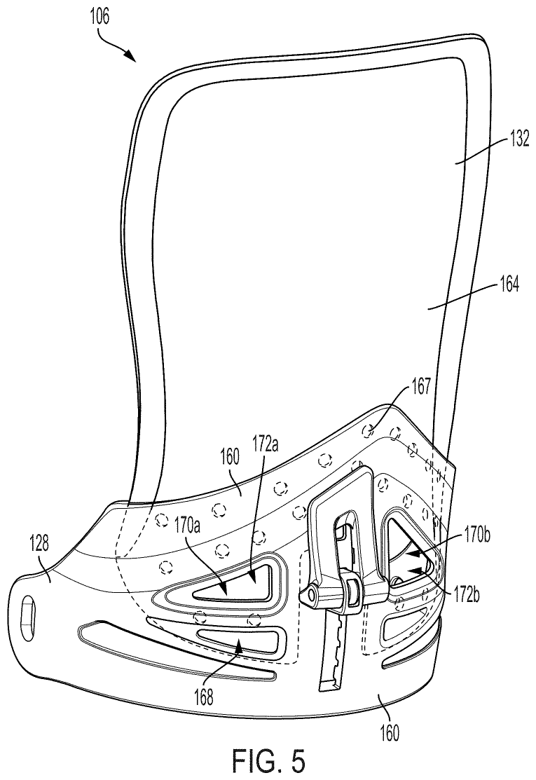

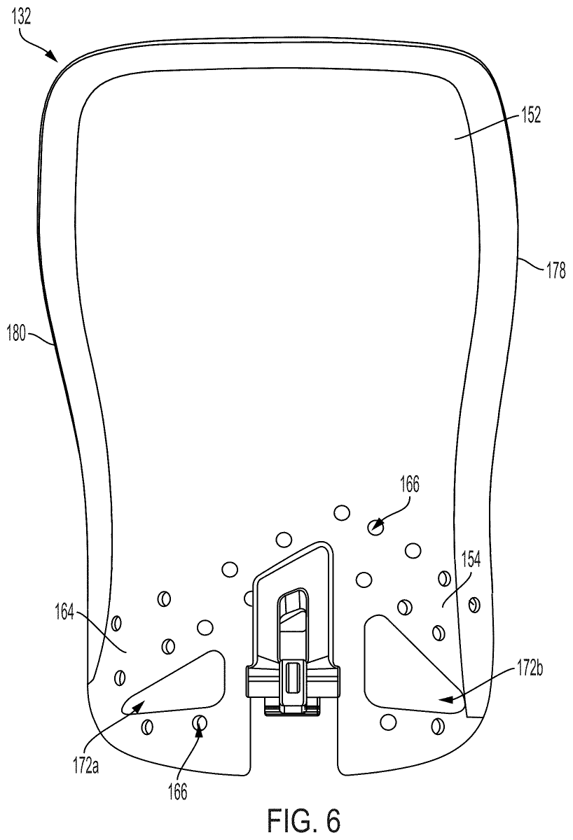

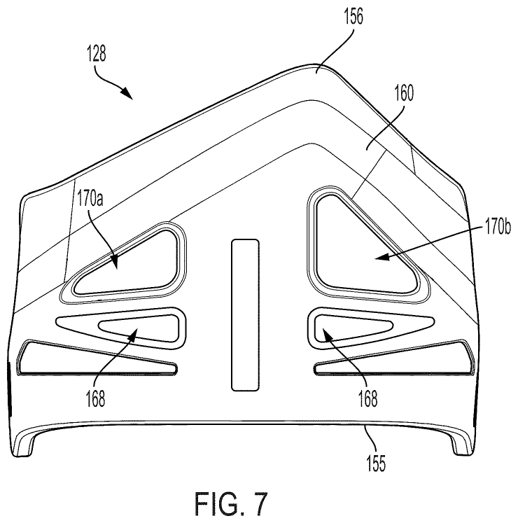

Referring now to FIGS. 3-7, the highback 106 of FIGS. 1-2 is shown separated from the other components of the snowboard binding 100 to more clearly highlight the design and advantages of the highback 106. FIGS. 3-5 show the entire highback 106, while FIG. 6 shows only the upper portion 132 and FIG. 7 shows only the lower portion 128 of the highback 106.

The highback 106 can generally be a nylon injection or composite blend, such as a glass or carbon filled injection. The upper portion 132 and the lower portion 128 of the highback 106 are each a different uniform material. The upper portion 132 is generally a more rigid material while the lower portion 128 is a less rigid material. While the lower portion 128 is a material meant to flex in response to an applied force from a user (particularly, along the “y” axis of the highback 106), the upper portion 132 is a material which maintains substantially a predetermined shape in response to the applied force. More specifically, the upper portion 132 is a material configured to maintain substantially a predetermined shape in response to an applied force from a rider to provide support and control. The lower portion 128, by contrast, is designed to flex in response to the applied force from a rider, allowing for maneuverability. In some cases, the lower portion 128 can specifically be configured to flex along a longitudinal axis, which is the general direction of the user's leg (i.e. the direction in which the highback 106 extends). While various materials can be used, as would be understood by one of skill in the art, in some cases the lower portion 128 of the highback 106 can be an injection plastic and the upper portion 132 can be a composite material, such as an extruded glass fiber with thermoplastic resin. In some cases, the upper portion 132 can be a composite glass fiber Polyethylene terephthalate glycol-modified lamination while the lower portion 128 can be an overmolded nylon material. Alternatively, other materials can be used. Notably, while certain advantageous materials are shown in described herein, other materials than those shown and described could also be used to effectively implement the subject technology, as would be understood by one of skill in the art. The particular materials described herein, while found to be effective, are for exemplary purposes only, and are not meant to limit the subject technology to a particular material type.

The upper portion 132 and lower portion 128 are coupled together in such a way that the materials remain separate and no additional fastening structure, or frame, is required. More particularly, the upper portion 132 can be described as two sections (although note that both are still part of the same uniform material of the upper portion 132), an upper section 152 and a lower section 154. When the upper portion 132 and lower portion 128 are coupled together, the lower section 154 of the upper portion 132 is anchored within the upper end 156 of the lower portion 128 (i.e. the end distal the baseplate 108 and opposite the lower end 155) of the highback 106. More specifically, the upper end 156 of the lower portion 128 has two support members, an inner support member 158 nearer the expected location of a rider's boot 102 and an outer support member 160 on the other side of the inner support member 158 with respect to the expected location from the rider's boot 102. The lower section 154 of the upper portion 132 is lodged between the two support members 158, 160, which close on inner and outer sides 162, 164 of the highback 106 in the lower section 154. The support members 158, 160 are joined in the areas around the periphery of the lower section 154 where they are not separated by the upper portion 132. Various advantageous features can also be included to allow the upper portion 132 to be securely lodged within the lower portion 128. For example, the lower section 154 can include a plurality of perforations 166 therethrough. The lower portion 128 can then be formed around the lower section 154 of the upper portion 132 by using an injection overmold, allowing the injection material of the lower portion 128 to fill the perforations 166 and form cylindrical connecting members 167 between the inner and outer support members 158, 160. In this way, the upper portion 132 and lower portion 128 are coupled together to securely form a highback 106 of a distinct upper portion 132 and lower portion 128. Since the upper portion 132 remains a separate material from the lower portion 128, it is able to respond to some forces separately from the lower portion 128 (and vice versa). However, the upper and lower portions 132, 128 are still inseparably attached since the upper portion 132 is anchored there within. No frame or other connecting mechanism which would impact the response and performance of the highback 106 is required. Further, since the portions 132, 128 are completely separately formed, and modular, various upper portions can be designed with different strength and/or flex characteristics but having a size and shape that allows them to be easily integrated into a standard lower portion 128 size and/or shape.

The highback 106 also includes a number of windows, including lower windows 168 and upper windows 170a, 170b (generally 170) on the lower portion 128. The upper portion 132 likewise includes windows 172a, 172b (generally 172), which correspond to the windows 170 when the upper portion 132 is anchored within the lower portion 128. The windows 168, 170, 172 assist in the manufacturing process and allow for the creation of the highback 106 as described in more detail below. In particular, non-circular (e.g. triangular or other non-circular shaped) windows can be used to prevent rotation during the manufacturing process, but other shapes, including circular, could also be used. In addition, the positioning and shape of the windows 168, 170, 172 is specified as shown and described to provide a particular advantageous torsional flex to the highback 106, such as along the y-axis of the highback. To that end, windows 170b, 172b, which are proximate a lateral edge 178 of the highback 106, can be significantly larger (i.e. 50-150 percent larger) than the windows 170a, 172a which are on the medial edge 180 of the highback to allow for asymmetric flex of the highback 106.

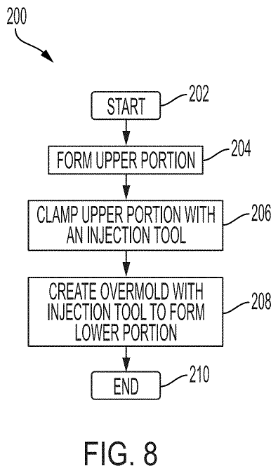

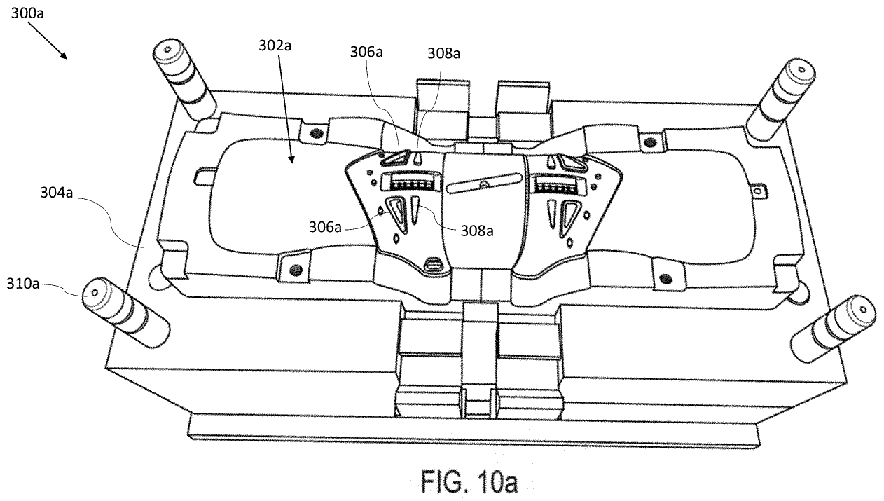

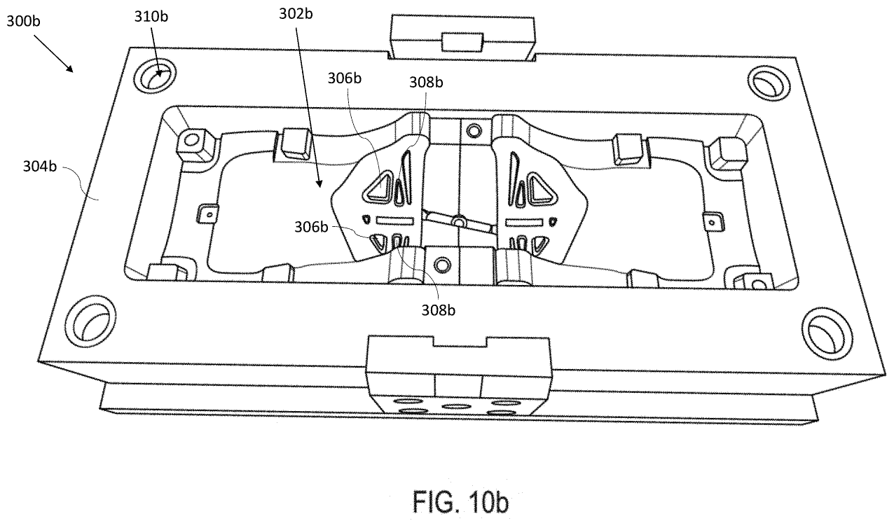

Referring now to FIG. 8, a flowchart 200 of a manufacturing process for a highback 106 in accordance with the subject technology is shown. The manufacturing process utilizes an injection tool, which can be seen in FIGS. 10a and 10b. The injection tool is a mold comprised of two clamshell sides 300a, 300b which fit together to form the overmold for the lower portion 128. Note that the exemplary sides 300a, 300b shown are used to form two lower portions 128 around two upper portions 132 simultaneously (i.e. forming two highbacks 106) and therefore are each symmetrical between left and right sides. It should be understood that this is by way of example only, and the injection tool need only be capable of forming a mold for a single highback lower portion 128.

The first side 300a of the injection tool has a convex interior 302a within an outer frame 304a, the convex interior 302a clamping the inner side 162 of the upper section 152 of the upper portion 132 while leaving space around the lower section 154 to form a mold for the inner support member 158 of the lower portion 128. The second side 300b has a concave interior 302b within an outer frame 304b, the concave interior clamping the outer side 164 of the upper section 152 of the upper portion 132 while leaving space around the lower section 154 to form a mold for the outer support member 160 of the lower portion 128. The injection tool includes pin details 306a, 306b in the shape of the windows 172 (i.e. triangular), which align with and extend through the windows 172 (and form windows 170 of the lower portion 128) to hold the upper portion 132 in place during assembly. The second side 300b includes male protruding pin details 306b while the first side 300a has female pin details 306a with an outer edge which couple with the male pin details 306b. Similarly, lower clamping members 308a, 308b extend from both sides 300a, 300b to grasp the lower section 154 of the upper portion 132 below the windows 172 during assembly. The frames 304a, 304b also include complimenting exterior supports 310a and apertures 310b, the supports 310 being configured for insertion into the apertures 310b to securely hold the sides 300a, 300b together during the assembly process.

Referring again to FIG. 8, the manufacturing process of the flowchart 200 can be used to form the components of the highback 106, as described above, and it should be understood that similar materials to those described with respect to the highback 106 can be implemented. As such, reference is made throughout the description of the flowchart 200 herein to the components of the highback 106 which are described herein.

The manufacturing process begins at step 202. An upper portion 132 of the highback 106 is then initially formed at step 204. The upper portion 132 can be formed from a composite material using thermoforming, or through various known methods such as injection, forged/pressed composite layups, or other methods as are known in the art. Thermoforming a composite material has been found to be advantageous as it results in a good strength to weight ratio, ideal flex, and allows for the easy substitution of one shape upper portion 132 with another. A plurality of perforations 166 are included which each extend through the entire upper portion 132 of the highback 106 in the lower section 154. The upper portion 132 also includes a number of windows 172 which can be non-circular in shape, as best shown in FIG. 7.

Once the upper portion 132 has been formed, an injection tool (e.g. FIGS. 10a-10b) is clamped around the upper portion 132 on either side 162, 164. The injection tool includes pin details 306a, 306b that are each in the shape of one of the windows 172 on the upper portion 132. Male pin details 306b engage female pin detail 306a counterparts through the windows 172 and on an opposing sides of the injection tool to hold the upper portion 132 in place and align the upper portion 132 and injection tool as opposing clamshell sides 300a, 300b are shut around the upper portion 132 for the mold for the lower portion 128. The pin details 306a, 306b each have a non-circular shape corresponding to one of the windows 172 (and corresponding to the opposing pin detail 306a, 306b on the other side). The non-circular shape prevents rotation of the upper portion 132 in the general plane of the upper portion 132 during the molding process, which can tend to exert a very high pressure on the highback 106. Notably, in other cases, the pin details 306a, 306b can be other shapes (as can the corresponding windows 172) which similarly hold the upper portion 132 in place. The pin details extending through windows 172 and ultimately create the windows 170 in the lower portion 132 as the injection material fills in the mold sides 302a, 302b around the pin details 306a, 306b. Thus, the lower portion 128 is created with windows 170 corresponding to the windows 172 in the upper portion 132.

The injection tool can also include lower opposing clamps 308a, 308b, which can also be non-circularly shaped (e.g. triangular or other shape). Unlike the pin details 306a, 306b, which extend through the windows 172 in the upper portion 132, the lower clamps 308a, 308b press against solid areas of the upper portion 132 on either side 162, 164 during the overmolding process. In this way, the lower opposing clamps 308a. 308b grasp the upper portion 132 to hold it in place as the lower portion 128 is formed. The lower windows 168 on the lower portion 128 are created around the lower clamps 308a, 308b of the insertion tool, and thus are a shape corresponding to the lower clamps 308a, 308b. The insertion tool can also clamp the upper portion 132 at an area just above the eventually formed upper end 156 of the lower portion 128, as discussed below.

At step 208, once clamshell sides 302a, 302b of the injection tool are in place around the lower portion 128, the lower portion 128 is created, forming an overmold by filling the shell of the injection tool. Thus, the material used for the lower portion 128 is provided to the injection tool for forming around the upper portion 132, forming the lower portion 128 substantially as shown herein. As such, the inner and outer support members 158, 160 of the lower portion 128 can be formed around the upper portion 132. Further, as the sides 302a, 302b of the injection tool are filled around the upper portion 132, the perforations 166 are filled with the material of the lower portion 128, forming connectors 167 between the support members 158, 160 of the lower portion 128.

After the lower portion 128 is fully formed, with the upper portion 132 being lodged between the support members 158, 160, the highback 106 is formed and the injection tool can be opened and removed. The process then ends at step 210, with the creation of a highback 106 including a frameless upper portion 132 and lower portion 128 which are securely bonded as described. Notably, the materials described herein can also be particularly advantageous during assembly of the highback 106. For example, an upper portion 132 formed from polyethylene terephthalate glycol-modified laminate while the lower portion 128 is an overmolded nylon material is effective. In such a case, the upper portion 132 has an ideal melting temperature which is low enough to facilitate a good bond with the nylon lower portion 128, but high enough to avoid melting when the lower portion 128 is overmolded, which would cause defects. The use of thermoplastic materials is also advantageous, at it is supportive but flexible and non-brittle. Overall, the final highback 106 is allows for flexing for comfort and control of the user, and provides support without being susceptible to cracking or other material failure.

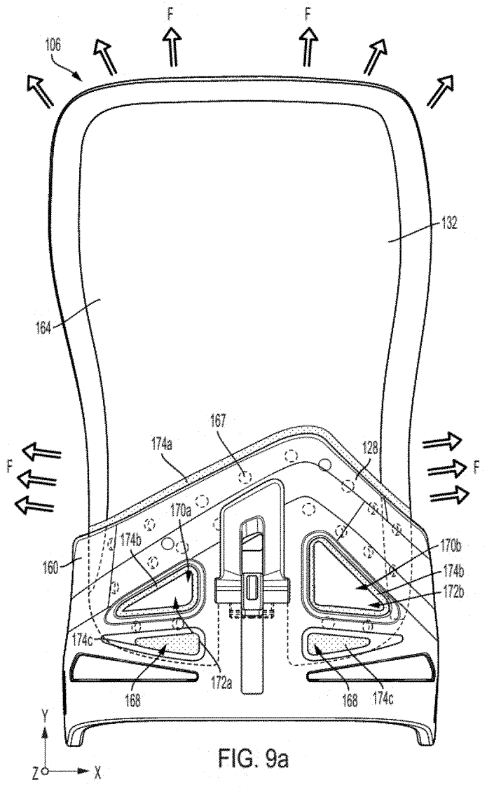

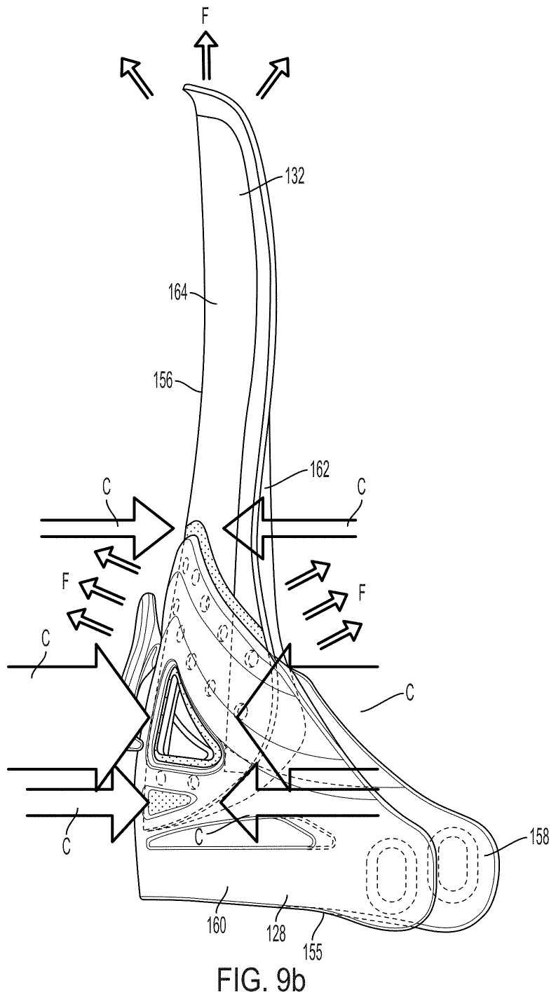

Referring now to FIGS. 9a-9b, the highback 106 is shown with clamping forces during assembly being illustrated. During the step of clamping the upper portion 204 and forming the lower portion 208, the insertion tool applies opposing clamping forces “C” on opposing sides 162, 164 of the upper portion 132. The particular areas where the insertion tool clamps the upper portion 174a, 174b, 174c (generally 174) are illustrated in shading. In particular, the insertion tool clamps the upper portion 132 at an area 174a just above the expected upper end of the lower portion 128, which is above the perforations 166. The insertion tool also clamps the upper portion 132 in a perimeter 174b around the windows 172. Finally, the insertion tool clamps a solid area 174c of the upper portion 132 below the windows 172. The clamping forces “C” hold the upper portion 132 and lower portion 128 together as the lower portion 128 is overmolded, resisting separation from external forces “F” in the “x” or “y” direction and/or rotation around the “z” axis. Providing the clamping surfaces 174 as shown allows for the highback 106 to be formed consistently and accurately while only affecting the flexure of the highback 106 as desired. While other clamping surfaces could be provided, a corresponding impact on flexure of the highback 106 would be expected.

Notably, while clamping of the highback 106 directly during the manufacturing process is shown, it is also possible to include pins on the injection tool which are placed outside the end product of the highback 106. These pins could be placed adjacent to the upper portion 132, or even on the upper portion 132, the tabs then being removed from the upper portion 132 after the highback is formed.

All orientations and arrangements of the components shown herein are used by way of example only. Further, it will be appreciated by those of ordinary skill in the pertinent art that the functions of several elements may, in alternative embodiments, be carried out by fewer elements or a single element. Similarly, in some embodiments, any functional element may perform fewer, or different, operations than those described with respect to the illustrated embodiment. Also, functional elements (e.g. connectors, fasteners, and the like) shown as distinct for purposes of illustration may be incorporated within other functional elements in a particular implementation.

While the subject technology has been described with respect to preferred embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed.

What is claimed is:

1. A highback for a snowboard binding comprising:
a first portion configured to couple the highback to a baseplate of the snowboard binding such that a proximal end of the first portion is proximate the baseplate; and
a second portion of a uniform material having:
a first section anchored within the first portion; and
a second section extending from a distal end of the first portion, the distal end opposite the proximal end, the second section extending in a direction away from the proximal end.

2. The highback of claim 1, wherein the first section of the second portion is lodged between two opposing support members of the first portion.

3. The highback of claim 2, wherein:
the first section of the second portion includes a plurality of perforations through the first section; and
the first portion includes a plurality of connecting members connecting the opposing support members of the first portion, each of the perforations being filled by a connecting member.

4. The highback of claim 1, wherein:
the first portion includes a first plurality of windows extending therethrough, the windows each being a non-circular shape; and
the first section of the second portion includes a second plurality of windows extending therethrough, the second plurality of windows each aligned with one of the first plurality of windows and having the non-circular shape of said window.

5. The highback of claim 4, wherein the first portion further includes a third plurality of windows extending therethrough, the third plurality of windows each being a non-circular shape, the third plurality of windows each surrounding a solid area of the first section.

6. The highback of claim 5, wherein the non-circular shape of each window is triangular.

7. A highback for a snowboard binding comprising:
a lower portion configured to couple the highback to a baseplate of the snowboard binding such that a lower end of the lower portion is proximate the baseplate; and
an upper portion of a uniform material having:
a lower section anchored within the lower portion; and
an upper section extending from an upper end of the lower portion such that the upper section is configured to support a leg of a rider when in use.

8. The highback of claim 7, wherein the lower section is lodged between opposing support members of the lower portion including an inner support member and an outer support member.

9. The highback of claim 8, wherein:
the lower section of the upper portion comprises a plurality of perforations through the lower section; and
the lower portion includes a plurality of connecting members extending through the perforations and connecting the inner support member and the outer support member of the lower portion.

10. The highback of claim 9, wherein:
the lower portion includes a first plurality of windows extending therethrough, each of the first plurality of windows being a non-circular shape; and
the lower section of the upper portion includes a second plurality of windows extending therethrough, the second plurality of windows each being a non-circular shape, the second plurality of windows aligned with the first plurality of windows.

11. The highback of claim 10, wherein the lower portion includes a third plurality of windows extending therethrough, the third plurality of windows each being a non-circular shape, the third plurality of windows each surrounding a portion of the lower section of the upper portion.

12. The highback of claim 7, wherein the lower portion is formed from a first material configured to flex in response to an applied force and the upper portion is formed from a second material configured to maintain substantially a predetermined shape in response to the applied force.

13. The highback of claim 12, wherein the lower portion is configured to flex along a longitudinal axis in response to the applied force, the longitudinal axis running between the lower end and the upper end of the lower portion.

14. The highback of claim 12, wherein the first material is an injection plastic and the second material is a composite material.

15. The highback of claim 12, wherein the first material is nylon and the second material is an extruded glass fiber with thermoplastic resin.

16. A method of manufacturing a highback for a snowboard binding comprising:
forming an upper portion of a composite material, the upper portion having a first plurality of windows, the first plurality of windows each being a shape;
clamping the composite upper portion on opposing sides of the upper portion with an injection tool such that a plurality of pin details of the injection tool are each inserted into one of the first plurality of windows, each pin having the shape of the window into which it is inserted; and
forming a lower portion around a lower section of the upper portion using the injection tool to create an overmold having an inner support member and an outer support member on opposing sides of the upper portion such that the upper portion is lodged between the inner support member and outer support member.

17. The method of claim 16, wherein:
the upper portion has a plurality of perforations therethrough; and
forming the overmold includes forming connecting members extending between the perforations to connect the inner support member and the outer support member.

18. The method of claim 16, wherein the step of clamping the composite upper portions on opposing sides of the upper portion with an injection tool further comprises clamping a plurality of non-circular opposing clamps on either side a plurality of solid areas of the lower section of the upper portion.

19. The method of claim 16, wherein the shape of the windows and pin details is non-circular.
